(19) United States
(12) Patent Application Publication
(10) Pub. No.: US 2007/0189251 A1
(43) Pub. Date: Aug. 16, 2007

(54) Power saving method for mobile terminal

(75) Inventor: Hunter Yao Hou, Nanjing (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/492,238

(22) Filed: Jul. 25, 2006

(30) Foreign Application Priority Data
Feb. 10, 2006 (CN) 200610077425.8

(51) Int. Cl. H04Q 7/24

(52) U.S. Cl. 370/338; 455/13.4

(57) ABSTRACT

A device for controlling a power level received by a feature of a mobile terminal includes a control unit for setting the power level to a first power level as a function of time. The control unit may also be configured to set the power level to a second power level as a function of time. The control unit may accept one or more user-defined values, such as a user-defined value for the first power level and user-defined values for a first predetermined time and a second predetermined time. The function of time may be a function of the first predetermined time and the second predetermined time. The mobile terminal may be an electronic device that is optionally battery-powered and may include a cell phone. The feature whose power lever is controlled by the device may include a light of a backlit viewing screen.

### FIELD OF THE INVENTION

This application is entitled to the benefit of and claims foreign priority under 35 U.S.C. § 119 from Chinese Patent Application No. 200610077425.8, filed Feb. 10, 2006, the disclosure of which is hereby incorporated by reference.

The present invention relates to power usage and, more particularly, to power saving systems and methods for mobile terminals.

### BACKGROUND OF THE INVENTION

In many countries, including the United States, mobile telephone or cell phone use is becoming ubiquitous. Mobile telephones are not only used for carrying on conversations real time, but also for sending and receiving short messages, e-mails and pictures. Other mobile terminals or mobile electronic devices, including personal digital assistants (PDAs), handhelds, laptops, etc., are also widely used.

The vast majority of mobile electronic devices are equipped with LCD view screens that use background lighting or backlighting to assist in viewing the information on the screen. Typically, a backlit LCD includes a layer or panel of pixels formed by liquid crystals sandwiched between two glass plates and electrically actuated to display an image and a background light installed at a back surface of the panel. The background light illuminates the back of the LCD screen to assist in displaying the LCD generated-image more accurately and vividly. By way of non-limiting example, the background light may be an electroluminescent panel placed behind the LCD panel.

The use of backlighting is particularly helpful when ambient lighting conditions are low. Unfortunately, however, although a backlit LCD display improves readability, it also draws more power than an ordinary LCD display does. Therefore, it is desirable to reduce the power consumed by the background lighting feature, especially in the case of mobile, battery-powered devices.

During transmission, the backlight on the viewing screen of most mobile phones is, by default, always turned on. When there is sufficient ambient lighting, backlighting the viewing screen is usually not necessary to adequately view the display. Thus, always having the background light turned on needlessly uses energy and runs down the batteries faster than is necessary.

With some electronic devices, users may be able to disable this default mode of having the backlight turned on, but typically this requires several steps and/or keystrokes. In some devices using backlit LCD view screens, the luminescence of the background light may be adjusted so that the brightness level of the background light is increased or decreased. For example, a brightness variation key or command may be provided for a user to manually set the brightness level of the background light to predetermined brightness levels. Typically, such a brightness variation key or command controls the level of current supplied to the background light. Most often, because of the inconvenience, users do not override the default mode.

### SUMMARY OF THE INVENTION

According to an embodiment of the present invention, a device for controlling a power level received by a feature of a mobile terminal includes a control unit for setting the power level to a first power level as a function of time. The control unit may also be configured to set the power level to a second power level as a function of time.

The control unit may accept one or more user-defined values, such as a user-defined value for the first power level and user-defined values for a first predetermined time and a second predetermined time. The function of time may be a function of the first predetermined time and the second predetermined time.

The control unit may be configured to receive a command to set the power level to a default power level. The default power level may be a user-defined value.

The mobile terminal may be an electronic device that is optionally battery-powered and may include a cell phone. The feature whose power lever is controlled by the device may include a light of a backlit viewing screen.

According to a further embodiment of the present invention, a power saving system for a viewing screen having a light includes a control unit to control power sent to the light as a function of a time. The time may be determined by a time determining device. The time determining device may include an internal clock. Alternatively, the time determining device could include a receiver configured to receive an externally generated time value.

According to an additional embodiment of the present invention, a method for controlling a characteristic of a feature of a mobile terminal includes setting a characteristic of the feature to a first predetermined attribute if a first time criteria is met. The method may further include setting a characteristic of the feature to a second predetermined attribute if a second time criteria is met. A list of features from which a user may select one or more may be supplied. The feature may be one of a light of a backlit viewing screen, a ring tone, an incoming call indicator and a call router.

According to even another embodiment of the present invention, a device for automatically controlling a luminescence level of a background light of a viewing screen includes a control unit for setting the luminescence level of the background light to a first predetermined brightness level if a time value meets a criteria. The criteria may include a determination of whether the time value falls within a time period defined between a first predetermined time and a second predetermined time. The control unit may be configured to accept user-defined values for the first and second predetermined times.

The device may be an electronic device that is optionally battery-powered. Further, the viewing screen may include a liquid crystal display. The device may be a cell phone.

It should be noted that the principles of the present invention could be applied to devices or terminals other than mobile telephones. Indeed, the invention contemplates controlling the backlight of other mobile electronic devices such as laptops, handhelds or other personal electronic devices. Further, although considered to be most useful in controlling the power usage in mobile electronic devices, which are powered at least part of the time with batteries, the principles of the present invention may also be applied to non-mobile devices having backlit viewing screens in order to generally reduce power usage.

It should also be noted that the principles of the present invention could be applied to features other than controlling the luminescence level of background lights for backlit viewing screens. By way of non-limiting examples, other features that a user may wish to automatically control as a function of time may include ring tone selection, ring tone volume, incoming call indicator mode, call routing mode, e-mail routing mode and automatic e-mail response.

### BRIEF DESCRIPTION OF THE DRAWINGS

The present invention will be better understood from reading the following description of non-limiting embodiments, with reference to the attached drawings, wherein below:

FIG. 1 is a flowchart according to an embodiment of the present invention;

FIG. 1A is a flowchart according to an aspect of the embodiment of FIG. 1;

FIG. 2 is a flowchart according to another embodiment of the present invention; and

FIG. 2A is a flowchart according an aspect of the embodiment of FIG. 2;

FIG. 3 is a flowchart according to a further embodiment of the present invention; and

FIG. 4 is a flowchart according to even another embodiment of the present invention.

### DETAILED DESCRIPTION

During daylight hours or in other high ambient lighting conditions, LCD viewing screens can be clearly viewed either without requiring any background light or with a reduced background lighting level. However, with most mobile terminals or mobile electronic devices the background light is on at full power whenever the viewing screen is activated. Automatically turning off, or reducing the luminescence level of, the background light of a backlit viewing screen could save energy, thereby providing extended hours of usage of a mobile, i.e. battery-powered, electronic device.

According to an embodiment of the present invention, a device for controlling a power level received by a feature of a mobile terminal includes a control unit for setting the power level to a first power level as a function of time. The present invention may, by way of non-limiting example, be incorporated into an electronic device such as a cell phone having a Liquid Crystal Display (LCD) panel lit from behind by an electroluminescent panel. Thus, the invention may control the power level received by the electroluminescent panel. As an example, the control unit may set the power level received by the electroluminescent panel to a first power level, say 20% of full power, when the time is between 8 am and 6 pm.

The control unit may also be configured to set the power level to a second power level as a function of time. Thus, using the same example as above, the control unit may set, for example, the power level received by the electroluminescent panel to a second power level, say 80% of full power, when the time is between 6 pm and 8 pm.

The control unit may accept one or more user-defined values. Thus, continuing with the above example, a user-defined value for the first power level, i.e. a setting of 20% of full power, may be entered into the control unit. Alternatively, the first power level may be set higher or lower by the user. Similarly, the second power level may also be a user-defined value.

The function of time may be a function of a first predetermined time and a second predetermined time. In the above example, the first predetermined time is 8 am and the second predetermined time is 6 pm. User-defined values for the first predetermined time and the second predetermined time may be entered into the control unit. Thus, a user could optionally set the first predetermined time to 7 am and the second predetermined time to 6:30 pm. In this case, the control unit would set the power level received by the electroluminescent panel to a first power level, say 25% of full power, when the time is between 7 am and 6:30 pm.

The control unit may be configured to receive a command to set the power level to a default power level. Continuing with the above example, assume that the control unit has set the power level received by the electroluminescent panel to a first power level, say 20% of full power, when the time is between 8 am and 6 pm. If the user enters a low-light area, say a movie theater, the first power level setting may not provide sufficient illumination of the viewing screen. In this situation, the user may send a command to the control unit, and the control unit, upon receiving the command, would set the power level to a default power level. The command could be, by way of non-limiting examples, a predetermined or pre-selected keystroke combination or a voice command. In many instances, the default power level will be 100% full power. However, the default power level may also be a user-defined value. Thus, the default power level need not be 100%.

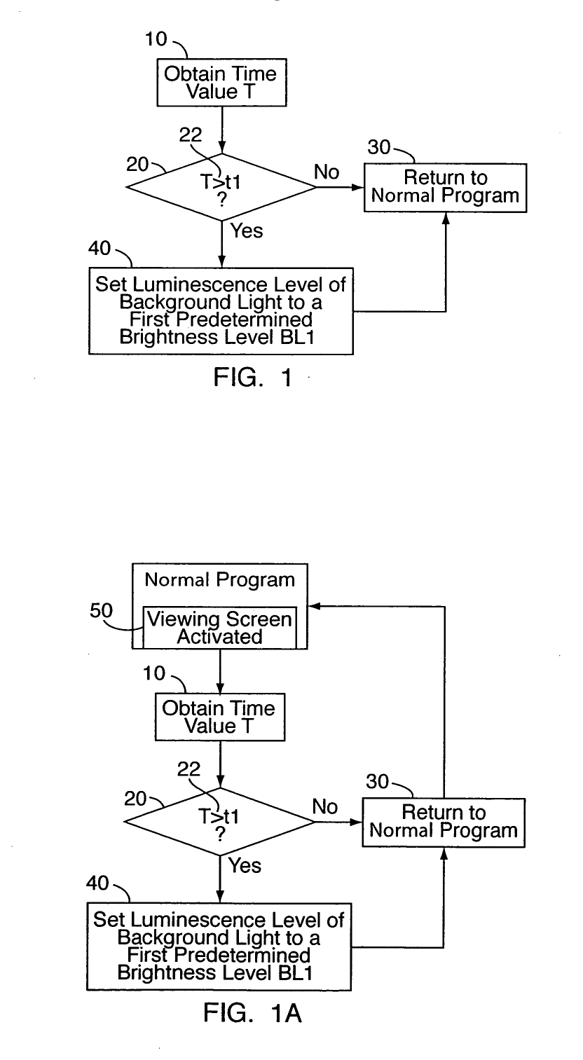

In one embodiment of the present invention, a method for controlling a luminescence level of a background light of a viewing screen is provided for use with an electronic device. FIG. 1 is a flowchart showing an example logic path for one such embodiment. The logic embodied in this flowchart is to be appended or incorporated as processing circuitry into the pre-existing processing circuitry of the electronic device that controls the operation of the device. Processing circuitry is any software system or subsystem or hardware system or subsystem (or combination thereof) that is capable of accepting, processing and outputting data (whether in analog or digital form). The pre-existing processing circuitry is hereinafter referred to as the “NORMAL” program. Thus, for example, the inventive processing circuitry could be contained within a software subroutine that is accessed or called at predetermined code in the NORMAL program. As a further example, the inventive processing circuitry could be at least partially hardwired into the electronic device.

In FIG. 1, at step 10, a time value, T, is obtained. Time value T may be obtained by sending a command to a clock algorithm that is part of the NORMAL program. Time value T preferably corresponds to the current time. Alternatively, time value T could be obtained from an external signal, for example, if the electronic device did not have its own clock algorithm. Optionally, a clock algorithm could be included in an inventive subroutine in order to obtain time value T.

At step 20, time value T is compared to a first predetermined time, t1 to determine if time value T meets a criteria 22 relative to the first predetermined time t1. In the embodiment shown in FIG. 1, the criteria 22 is whether or not time value T is greater than the first predetermined time t1. If the time value T does not meet the criteria 22, the program would be returned to the NORMAL program as shown in step 30. If the time value T meets the criteria 22, or as presented in this particular embodiment, time value T is greater than the first predetermined time t1, then a command would be sent, as shown in step 40, to set the luminescence level of the background light to a first predetermined brightness level, BL1. From step 40, the program would then return to the pre-existing NORMAL program.

A control unit may be used to set the luminescence level of the background light. A control unit is any software system or subsystem or hardware system or subsystem (or combination thereof that is capable of outputting a signal in response to receiving one or more inputs. Inputs may be in analog or digital form. The control unit may be stand alone or may be integrated into a larger system.

FIG. 1A is a flowchart showing an aspect of the present invention, with respect to the embodiment shown in FIG. 1. As shown at step 50, the viewing screen is activated. Typically this activation of the viewing screen would occur within the NORMAL program of the device. In the context of the present invention, a screen is considered to be activated when it is turned on or when it is awakened from a “sleep” or “suspend” mode. According to the flowchart of FIG. 1A, every time the viewing screen is activated, the inventive program obtains time value T (see step 10) and then proceeds to determine if the time value meets the criteria (see step 20).

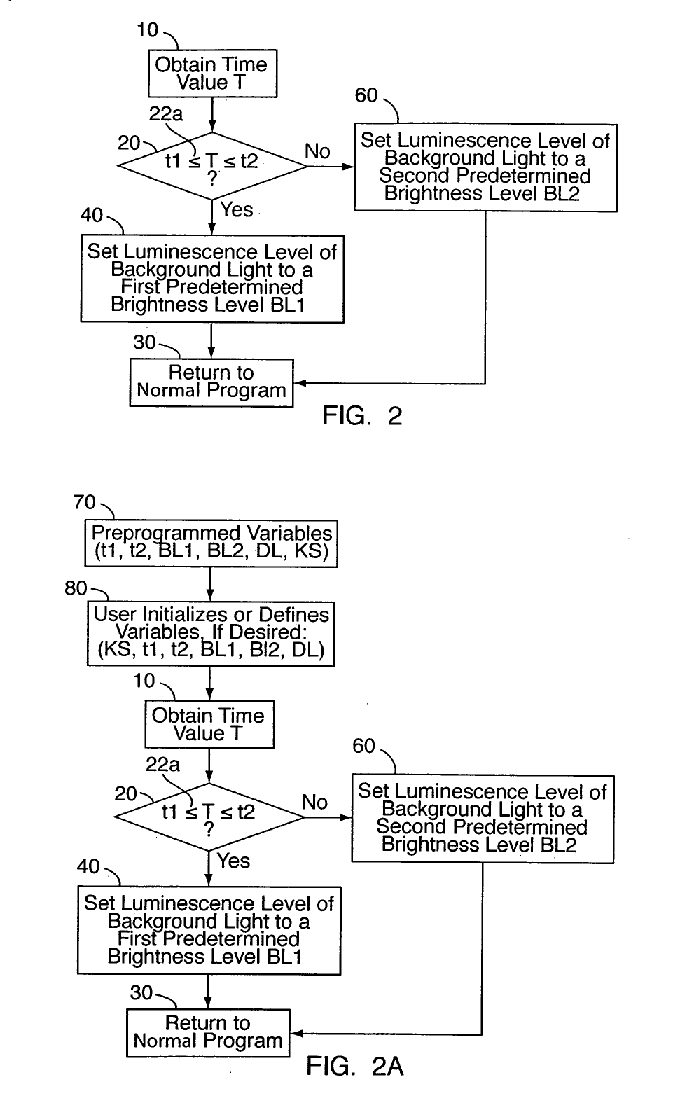

The logic path associated with another embodiment of the present invention is presented in the flowchart of FIG. 2. As with the embodiment disclosed in FIG. 1, at step 10, a time value, T, is obtained. At step 20, criteria 22a is introduced. Criteria 22a may be met, for example, when time value T is greater than or equal to a first predetermined time t1 and when time value T is less than or equal to a second predetermined time t2. Other criteria may be suitable. As another non-limiting example, the criteria may be met when time value T is greater than a first predetermined time t1 and when time value T is less than a second predetermined time t2. It is expected that the first predetermined time and the second predetermined time would preferably be set to bracket the period when the sun is up.

If it is determined at step 20 that the time value T meets the criteria 22a, then a command would be sent, as shown in step 40, to set the luminescence level of the background light to a first predetermined brightness level, BL1. From step 40 the program would be returned to the pre-existing NORMAL program. If the time value T does not meet the criteria 22a, then a command would be sent, as shown in step 60, to set the luminescence level of the background light to a second predetermined brightness level, BL2. From step 60, the program would also be returned to the pre-existing NORMAL program

In general, in the absence of the present invention, when the backlit viewing screen is activated, the background light brightness level will be set to a preprogrammed default level, typically full power or 100%. In one aspect of the present invention, the user may set certain parameters or variables using a power save set-up program or subroutine. The power save set-up program may allow the user to initialize or define:
a predetermined default brightness level, DL;
a first predetermined brightness level, BL1;
a second predetermined brightness level, BL2;
a first predetermined time, t1;
a second predetermined time, t2; and
an override key stroke sequence, KS.
   In the absence of a user initializing these variables, they may be provided with default values by the program. For example, the preprogrammed default value for a default brightness level may be 100%, while a user may decide to set the default brightness level to 80% of the preprogrammed default value in order to save power even in low ambient light conditions. Similarly, the first predetermined brightness level may have a preprogrammed default setting of 0% (i.e. be completely off), but some users may prefer to set the first predetermined brightness level to 10% in order to provide a minimal level of backlighting even under daylight ambient lighting conditions. The predetermined times, t1 and t2, may have preprogrammed default values of 8:00 am and 6:00 pm, respectively, which a user in Alaska during the summer may desire to set at 5:00 am and 8:00 pm, respectively.

FIG. 2A is a flowchart showing this above-discussed aspect of the present invention, with respect to the embodiment shown in FIG. 2. As shown at step 70, certain variables may be set or defined by the program and then in step 80, the user may initialize or define one or more of these variables to the user's personal settings. Step 80 need only be performed once, it at all, prior to the user operating the device multiple times.

Alternatively, the first and second predetermined times could be determined from data stored in memory in the device. For instance, t1 and t2 could be read from a table of sunrise and sunset times or interpolated from a reduced stored data set of sunrise/sunset times. As another option, the first and second predetermined times could be received on a daily basis from an externally transmitted signal that, for example, corresponds to sunrise/sunset times.

In another embodiment, a device incorporating the present invention could automatically reduce the amount of power used by a backlit viewing screen by determining the time of day and reducing power to the screen when ambient light conditions are expected to be high. During daylight hours, the power saving system could automatically turn off the background light of the backlit viewing screen; at night, the power saving system could allow the background light to be on.

However, in some instances during daylight hours the user may desire background lighting. Thus, in another aspect of the present invention, in those instances when background light is desirable during the day, a user could override the automatic power saving function and use, for example, a predetermined key combination to return the background lighting level to a default level. In most instances, the default level would be preset by the manufacture to 100%. As discussed above, one aspect of the present invention allows the user to set his or her personal background lighting default level. This predetermined default level may be set, for example, at 90% of the manufacturer's default level, depending upon the personal preferences and viewing conditions that a user expects to encounter.

As an example of another alternative embodiment of the present invention, a series of pseudo-code statements are presented below. These pseudo-code statements are meant to illustrate an example of one logical path that could be followed to implement the present invention, without being tied to or associated with any particular programming language.

```
Power on mobile device
Set time to correct time
Do you want to turn on background light in any case?
  if (Yes)
    then {
        Always turn on light until next power on
        Go to NORMAL
        }
      else {if (there's an incoming call) or ( send short message) or
        (get short message)
            then {
                Get current_time
            if (current_time is after 8:00am and current_time is
            before 6:00pm) or (current_time is after 8:00 and before
            18:00)
                then {
                    turn off background light
                    }
                else turn on background light
                }
        }
```

NORMAL:

The Pre-existing Normal Processing Algorithm.

In another aspect of the present invention, another series of pseudo-code statements are presented below. These pseudo-code statements are meant to illustrate an example of one logical path that could optionally be included to supplement the code of the above paragraph.

```
if ( during daytime, it is desired to turn on background light because
ambient light is low)
    then {
        press a special key or key combination, (e.g., *123)
        turn on the background light
        }
if ( it is desired to turn off background light ambient light is not low)
    then {
        press the above special key
        turn off the background light
        }
```

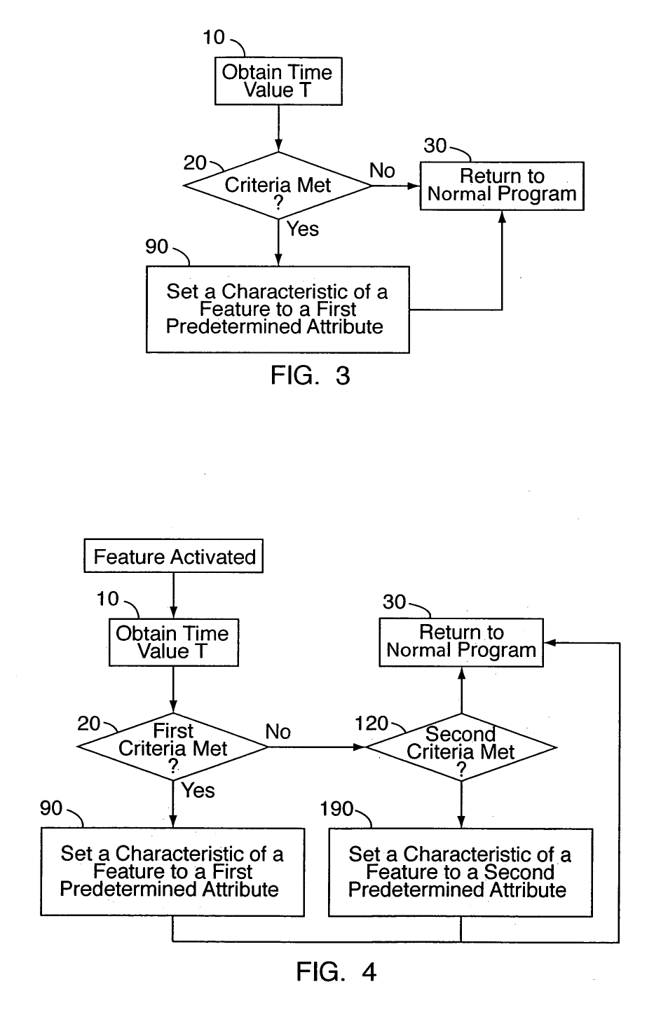

The principles of the present invention could be applied to features other than background lights for backlit viewing screens. Thus, as shown in FIG. 3, one embodiment of the inventive method encompasses a method for controlling a feature of a handheld electronic device including obtaining a time value (step 10), determining if the time value meets a criteria relative to a first predetermined time period (step 20), and setting a characteristic of the feature to a first predetermined attribute if the criteria is met (step 90).

By way of non-limiting examples, features that a user may wish to automatically control as a function of time may include ring tones, incoming call indicators and call routings. Thus, in a general sense, the present invention could allow a user to personalize a variety of features of the electronic device as a function of time.

For example, a user may desire to have ring tone volume muted during the day, but at full volume during evening activities. In this example, the feature being controlled is the ring tone, the characteristic being set is the volume, and attribute is the volume level being either muted (i.e. for example, at 50% of full volume) or on full. As another example, a user may desire to have a first ring tone during the day and a second ring tone during the evening. In this example, the feature being controlled is still the ring tone. However, the characteristic being set is the ring tone selection, and attribute is the particular song or sound that is selected for the ring tone.

As even another example, a user may desire to have incoming calls indicated by a vibration mode during certain time periods, but as a ring tone during other time periods. In this example, the feature being controlled is the call indicator, the characteristic being set is the mode, and the attribute is vibration, ring tone, etc.

As even another example, a user may desire to have incoming calls routed to various destinations during different time periods. For example, during working hours, all incoming phone calls could be routed to a work phone number, while during commuting time periods, all incoming phone calls could be routed directly to voice mail.

FIG. 4 is a flowchart showing another embodiment of the present invention. In this embodiment, multiple criteria are defined. As with the embodiment of FIG. 3, if the first criteria is met, then the characteristic is set to a first predetermined attribute. However, if the first criteria is not met, then the program determines if the time value meets a second criteria relative to another predetermined time period (step 120). If this second criteria is met, the characteristic of the feature is set to a second predetermined attribute (step 190). If the second criteria is not met, the program returns to the NORMAL program and a default value for the attribute is applied. As a non-limiting example of this embodiment, incoming calls could be forwarded to a first phone number (a first predetermined attribute) during a first time period, to a different phone number (a second predetermined attribute) during a second period and not forwarded at all (the default) during a third time period. In the general case, any number of criteria for a given feature could be defined and checked. Moreover, in the general case, any number of different characteristics for a given feature could be set upon a selected criteria being met.

Since certain changes may be made in the above-described power saving system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

I claim:

1. A device for controlling a power level received by a feature of a mobile terminal, the device comprising:
a control unit for setting the power level to a first power level as a function of time.

2. The device of claim 1 wherein:
the control unit is configured to set the power level to a second power level as a function of time.

3. The device of claim 1 wherein:
the function of time is a function of a first predetermined time and a second predetermined time.

4. The device of claim 1 wherein:
the control unit is configured to accept one or more user-defined values.

5. The device of claim 4 wherein:
a user-defined value is the first power level.

6. The device of claim 4 wherein:
the user-defined values include a first predetermined time and a second predetermined time.

7. The device of claim 1 wherein:
the control unit is configured to receive a command to set the power level to a default power level.

8. The device of claim 1 wherein:
a user-defined value is a default power level.

9. The device of claim 1 wherein:
the mobile terminal is an electronic device that is optionally battery-powered.

10. The device of claim 1 wherein:
the mobile terminal includes a cell phone.

11. The device of claim 1 wherein:
the feature includes a light of a backlit viewing screen.

12. A power saving system for a viewing screen having a light, the system comprising:
a control unit to control power sent to the light as a function of time.

13. The system of claim 12 wherein:
the time is determined by a time determining device.

14. The system of claim 13 wherein:
the time determining device includes one of an internal clock and a receiver configured to receive an externally generated time value.

15. The system of claim 12 wherein:
the viewing screen is incorporated into a cell phone.

16. A method for controlling a characteristic of a feature of a mobile terminal, the method comprising the step of:
setting a characteristic of the feature to a first predetermined attribute if a first time criteria is met.

17. The method of claim 16 further comprising the step of:
setting the characteristic of the feature to a second predetermined attribute if a second time criteria is met.

18. The method of claim 16 further comprising the step of:
supplying a list of features from which a user may select one or more.

19. The method of claim 16 wherein:
the feature is one of a light of a backlit viewing screen, a ring tone, an incoming call indicator and a call router.

20. The method of claim 16 wherein:
setting a characteristic of the feature includes setting the power level of a light to a first power level.
